(19) United States
(12) Patent Application Publication
(10) Pub. No.: US 2026/0229963 A1
(43) Pub. Date: Aug. 6, 2026

(54) Bus Bar Carrier with Wire Clip

(71) Applicant: Schaeffler Technologies AG & Co. KG, Herzogenaurach (DE)

(72) Inventor: Brian Foust, Akron, OH (US)

(73) Assignee: Schaeffler Technologies AG & Co. KG, Herzogenaurach (DE)

(21) Appl. No.: 19/532,122

(22) Filed: Feb. 6, 2026

Related U.S. Application Data
(60) Provisional application No. 63/754,678, filed on Feb. 6, 2025.

(51) Int. Cl. H02K 11/00; H02K 1/16; H02K 11/25

(52) U.S. Cl. CPC H02K 11/0094; H02K 1/16; H02K 11/25

(57) ABSTRACT

A bus bar assembly for a stator assembly of an electric motor. The bus bar assembly includes a bus bar in conductive communication with a plurality of windings of the stator assembly. The bus bar includes a main body portion and a plurality of bus tabs in conductive communication with select windings of the plurality of windings. The bus bar assembly further includes a bus bar carrier having a body supporting the bus bar. A wire clip assembly of the bus bar assembly is supported by the bus bar carrier. The wire clip assembly is configured to receive and secure therein at least a portion of an electric wire.

### CROSS-REFERENCE TO RELATED APPLICATIONS

The present application claims the benefit of U.S. provisional patent application 63/754,678, filed 6 February 2025, the content of which is incorporated by reference herein in its entirety.

### TECHNICAL FIELD

The disclosure relates to a bus bar carrier with a wire clip.

### BACKGROUND

Electrical machines having a rotor and a stator have several applications, such as but not limited to drive machines designed as internal rotor, i.e., the stator surrounding the internal rotor. A moving magnetic field is generated via the stator causing the rotor to rotate. For this purpose, the stator includes a winding with a large number of conductors, where each conductor is assigned one or usually more than one phase. A bus bar being a solid metallic strip or bar is used to conduct and distribute high currents within the stator.

During the operation of the electric machine, the winding temperature may be recorded using an NTC resistor element (NTC sensor) to monitor the status of the electrical machine. In some examples, the NTC sensor is located in a hotspot of the stator requiring additional wiring to connect to the NTC sensor. As such, it is desirable to have an improved bus bar assembly supporting the NTC sensor wire.

### SUMMARY

The present disclosure relates generally to electric motors and more particularly to a bus bar assembly for a stator assembly of an electric motor. The bus bar assembly is configured to facilitate reliable electrical connection with stator windings while providing efficient and secure management of associated wiring within the stator.

According to aspects of the present disclosure, the bus bar assembly includes a bus bar that is in conductive communication with a plurality of stator windings. The bus bar includes a main body portion and a plurality of bus tabs configured to make electrical connections with selected stator windings. The bus bar is supported on a bus bar carrier having a carrier body which provides structural support and positioning within the stator assembly.

The bus bar assembly further includes a wire clip assembly supported by the bus bar carrier. This wire clip assembly is configured to receive and securely hold at least a portion of an electric wire, thereby preventing disconnection or damage during motor assembly and operation. The wire clip assembly comprises a clip carrier extending from the bus bar carrier, supporting at least one wire clip that extends outwardly from the clip carrier. In one or more example embodiments, the clip carrier and the bus bar carrier are integrally formed as a unitary part to simplify construction and improve reliability as well as to prevent or reduce damage to the electrical wire.

Each wire clip includes first and second arms that define a receptacle for receiving and securing the wire, with arm lengths configured to provide a firm, press-fit retention of the wire. Multiple wire clips may be arranged in spaced relation along the clip carrier, defining a wire path that can include one or more bends to accommodate wiring layouts within the stator.

Additional features include guide tabs along the bus bar carrier that cooperate with the wire clips to define and support the electric wire’s path, enhancing wire retention and protection. The bus bar assembly and its wire clip arrangement improve manufacturing ease, secure electrical connections, and reduce potential wiring damage.

In some embodiments, the present disclosure further contemplates a stator assembly for an electric motor incorporating the described bus bar assembly and wire clip assembly. The stator assembly may include a temperature sensor, such as a negative temperature coefficient (NTC) thermistor, with electrical wiring secured by the wire clip assembly, enabling reliable temperature monitoring for motor protection and control.

The described bus bar and stator assemblies thereby provide enhanced integration of electrical components and wiring management, contributing to improved motor operational reliability.

Overall, the disclosed bus bar assembly and stator assembly provide an effective solution for integrating electrical connections and wire management in electric motors, leading to improved manufacturing efficiency, electrical reliability, and ease of maintenance.

### BRIEF DESCRIPTION OF DRAWINGS

FIG. 1 is a top view of a stator assembly having a bus bar assembly with a wire clip according to an example embodiment.

FIG. 2 is a top view of a portion of the stator assembly of FIG. 1 showing the bus bar assembly and wire clip.

FIG. 3 is a perspective view of a top portion of the stator assembly of FIG. 1 showing a radial inward view of the bus bar assembly and wire clip.

FIG. 4 is another perspective view of the top portion of the stator assembly showing a radially outer view of the bus bar and wire clip.

FIG. 5 is a front perspective view of the bus bar assembly and wire clip of FIGS. 1-4.

FIG. 6 is a back perspective view of the bus bar assembly and wire clip of FIG. 5.

FIG. 7 is a front perspective view of a portion of the bus bar assembly with the wire clip.

FIG. 8 is a front perspective view of the bus bar assembly and wire clip according another example embodiment.

Like reference symbols in the various drawings indicate like elements.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to "only one" unless explicitly indicated to the contrary. Thus, for example, reference to “a component” includes embodiments having two or more such components unless the context clearly indicates otherwise.

As used herein, the term “axial” and derivatives thereof, such as “axially,” shall be understood to refer to a direction along the axis of a shaft configured to rotate in operation of the apparatus described herein. Further, the term “radial” and derivatives thereof, such as “radially,” shall be understood in relation to the axis of the aforementioned shaft. For example, “radially outboard” refers to further away from the axis, while “radially inboard” refers to nearer to the axis.

As used herein, the term “plurality” shall be understood to refer to two or more. The term “weld bond” shall be understood to refer to a member that welded to another member with or without additional filler rod material.

In general terms, the present disclosure is directed to a stator for an electric motor and in particular to a bus bar assembly for the stator. The bus bar assembly includes a wire clip or securement mechanism for holding a wire, such as the wire of the stator’s negative temperature coefficient (NTC) sensor/thermistor, so that the wire does not become disconnected or otherwise damaged during assembly or operation of the electric motor.

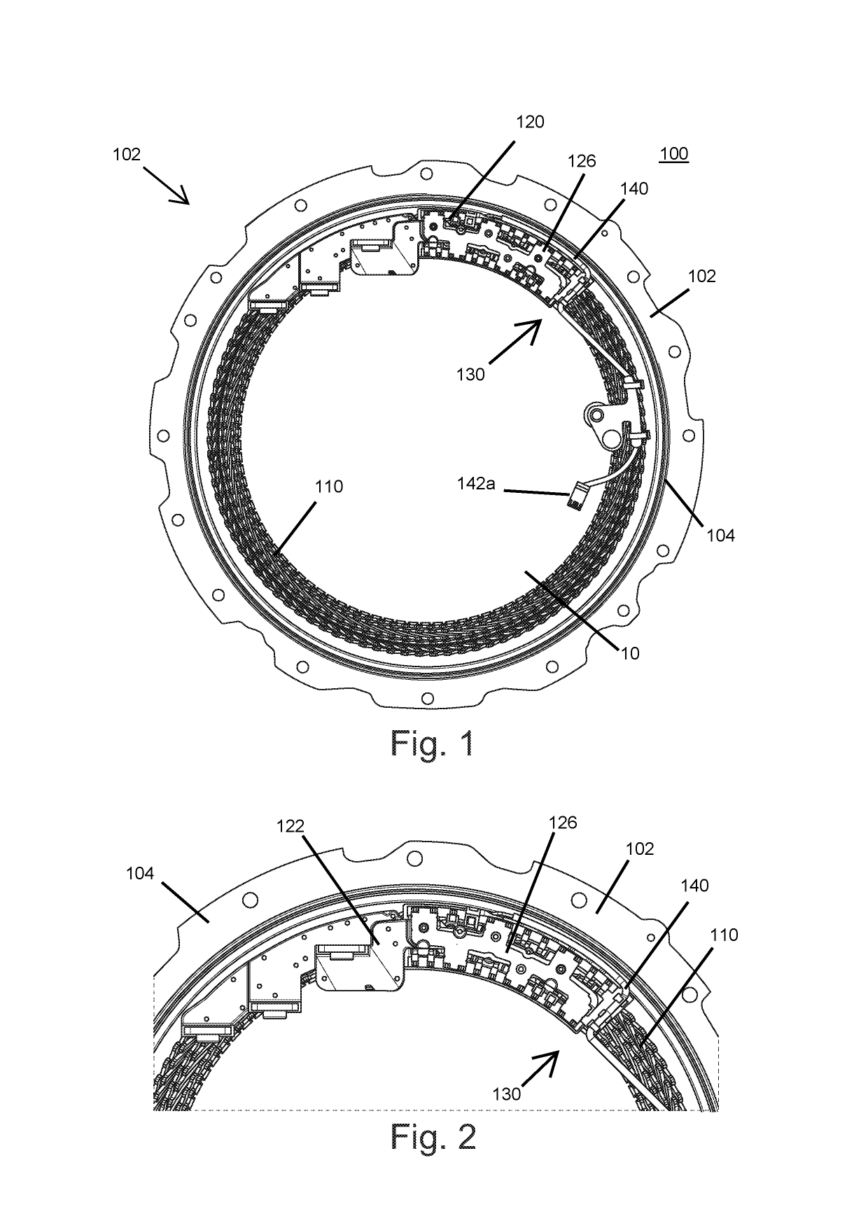

Referring to FIGS. 1-7, there is disclosed a stator assembly 100 for an electric motor including a stator 102 having a stator carrier or housing 104 that extends along an axis between a top side 103 and a bottom side (not shown) and defines an opening 10 therein. The stator 102 of the stator assembly 100 includes a plurality of windings 110 located within the stator carrier 104. The stator assembly 100 further includes a bus bar assembly 120 which is attached to at least the stator carrier 104 along an axial end portion thereof. The bus bar assembly 120 includes a bus bar carrier 122 having a carrier body. The bus bar carrier 122 is formed of a plastic or other electrically nonconductive material. In addition, the bus bar assembly 120 includes a bus bar 126 supported by the bus bar carrier 122. The bus bar 126 is constructed from an electrically conductive material.

As shown, the bus bar carrier 122 may have a multi-piece or single-piece construction. In some examples, the bus bar carrier 122 defines multiple holes configured for receiving therein windings 110 of the stator 102. The winding-receiving holes provide for, among other things, improved fixation of the bus bar carrier 122 within the stator assembly 100.

The bus bar 126 may include a main body portion 126a and bus tabs 126b extending into electrically conductive communication with select windings 110. In some examples, each of the plurality of bus bar tabs 126b is in electrical conductive communication with different ones of the windings 110. It should be appreciated that, unless explicitly stated, the electric motor in which the stator assembly 100 is utilized may be incorporated into any structure (e.g., an electric axle or other components of a vehicle) and/or utilized for any function where it is beneficial to reduce relative movement (e.g., vibration) and/or secure the connection between the stator carrier 104 and/or the bus bar carrier 122 and the motor housing.

According to one or more example embodiments, the bus bar assembly 120 includes a wire clip assembly 130 supported by the bus bar carrier 122. The wire clip assembly 130 receives an electric wire 140 and maintains the wire in a secure, fixed position. In one or more example embodiments, the wire clip assembly 130 includes at least one clip 134 and a clip carrier 132 supporting the at least one clip 134, where the at least one clip 134 extends outwardly from the clip carrier 132. In at least one implementation, the clip carrier 132 includes a flat or planar surface from which the at least one clip 134 extends. It is understood, however, that the clip carrier 132 may have a non-planar surface from which the at least one clip 134 extends.

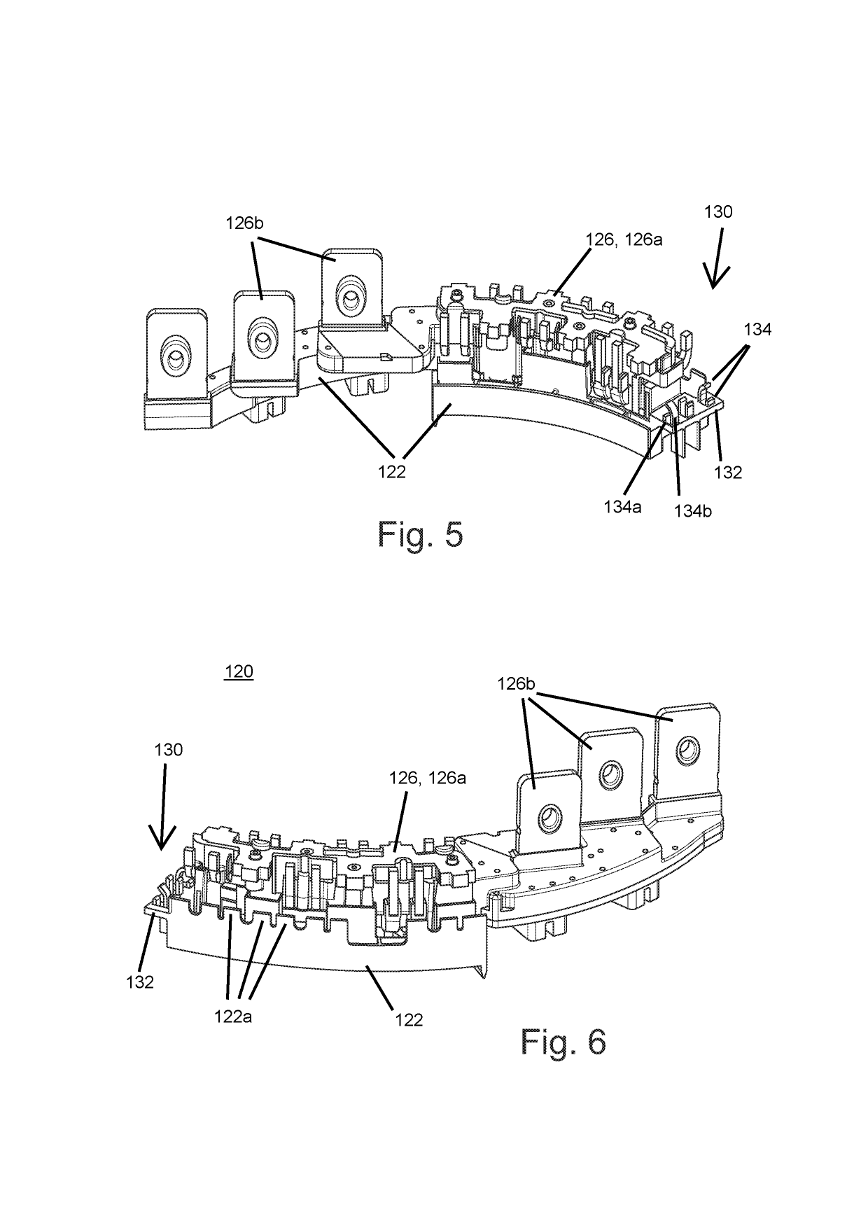

In one example embodiment, the clip carrier 132 extends from and/or forms part of the bus bar carrier 122. In an implementation, the clip carrier 132 is integrally formed with the bus bar carrier 122 as a unitary part. Best seen in FIGS. 5-7, the clip carrier 132 extends from a circumferential end portion of the bus bar carrier 122, relative to the stator assembly 100. It is understood that the clip carrier 132 may extend from other locations of the bus bar carrier 122.

In an alternative embodiment, bus bar carrier includes a first bus bar carrier portion 122’ and a second bus bar carrier portion 122”, as shown in FIG. 8. In this embodiment, the first bus bar carrier portion 122’ may be, for example, a plastic overmold of the bus bar 126 (bus bar main body portion 126a and/or tabs 126b), i.e., the conductive part of the bus bar for passing electric current during operation of the electric motor; and the second bus bar carrier portion 122” may be a plastic body having an underside which receives the windings 110, with the plastic body supporting the bus bar 126 and corresponding plastic overmold 122’. In this embodiment, the clip carrier 132 is integrally formed with the second bus bar carrier portion 122” and is integrally formed with the first bus bar carrier portion 122’ when the second bus carrier portion 122” is mechanically connected to the first bus bar carrier portion 122’. The first bus bar carrier portion 122’ and the second bus bar carrier portion 122” may be connected together by any of a number of approaches such as, for example, an adhesive such as an epoxy or glue, plastic welding or riveting, thermal staking, a mechanical snap-fit and/or press-fit coupling, etc. In yet another alternative embodiment, the clip carrier 132 extends from the first bus bar carrier portion 122’.

The wire clip assembly (clip carrier 132 and at least one clip 134) and the bus bar carrier 122 may be an integrated, unitary part and/or from a uniform material.

In some examples, the at least one clip 134 of the wire clip assembly 130 include a plurality of clips 134. Referring to FIGS. 5-7, each clip 134 includes a first arm 134a and a second arm 134b. Each arm 134a, 134b has a first end connected to the clip carrier 132 and a second end extending away from the clip carrier 132. The first and second arms 134a, 134b of a clip 134 together define a receptacle for receiving a portion of the wire 140 therein. The receptacle formed by the first and second arms 134a, 134b may have a rounded cross-sectional shape (e.g., arms 134a, 134b each having a curved length) to receive a rounded cross-sectional portion of the wire 140 in a press-fit arrangement. It is understood, however, that the cross-section of the receptacle formed by arms 134a, 134b of a clip 134 may have other shapes.

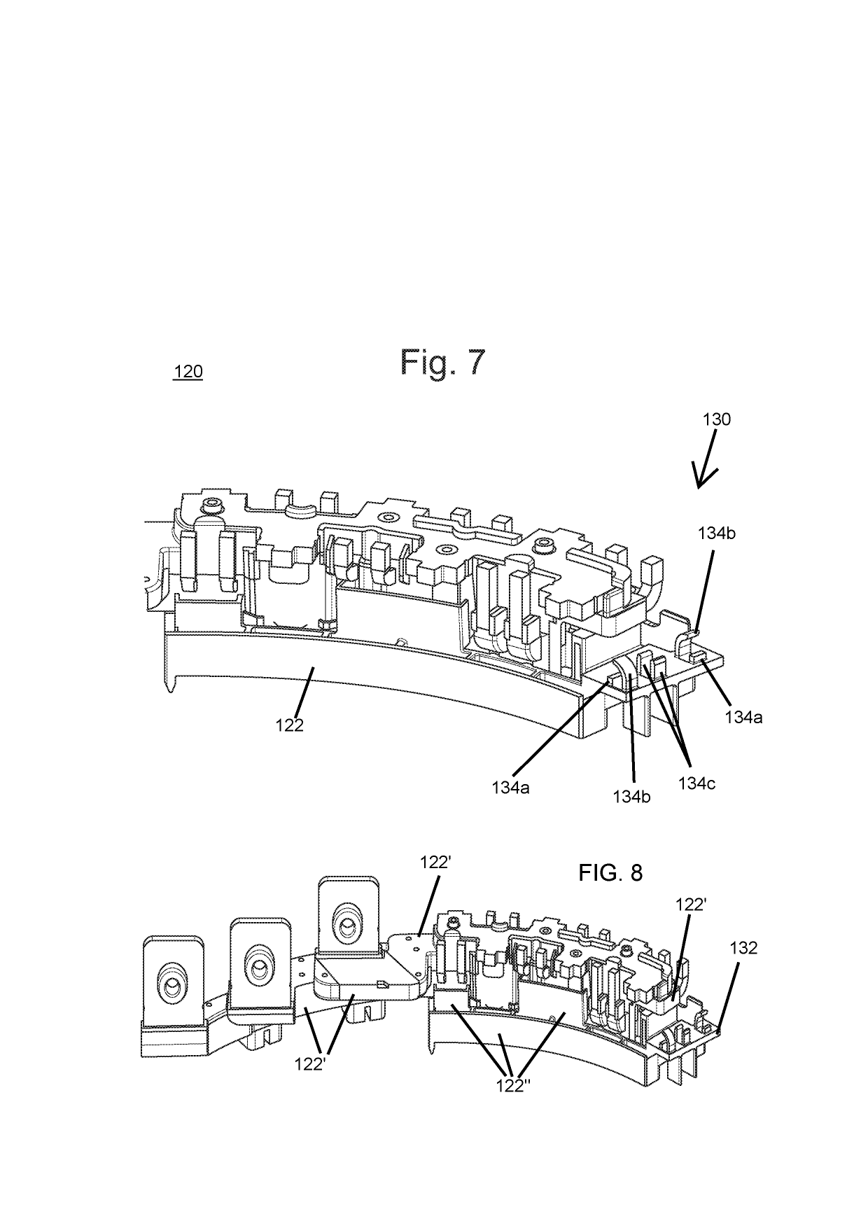

As shown in FIGS. 5-7, a first length between the first and second ends of an arm 134a, for example, may be less than a second length between the first and second ends of the corresponding second arm 134b of the arm pair forming a clip 134. The difference in arm lengths allows the arms 134a, 134b to hold the wire 140 in a retained position when the wire 140 is pressed into the clip 134. In addition or in the alternative, a clip 134 may include first and second arms 134c having the same length, as shown in FIG. 7. It is understood that the length of the arms 134 and/or the arm length difference of an arm pair forming a clip 134 of the wire clip assembly 130 may vary.

In some examples, a plurality of clips 134 of the wire clip assembly 130 are positioned to route a portion of the wire 140 so as to secure the wire portion and prevent the wire 140 from being damaged. The clips 134 are spaced apart from each other along the clip carrier 132 so as to define a path along the clip carrier for the wire portion received by the clips 134. FIGS. 1-3 illustrate a wire 140 received by the clips 134. Though the clips of the wire clip assembly 130 may be arranged so as to define a largely linear path of the portion of the wire 140 along the clip carrier 132, it is understood that the clips 134 may be arranged relative to each other on the clip carrier 132 so that the clipped portion of the wire 140 has a nonlinear path.

In some example embodiments, the bus bar carrier 122 may include a plurality of guide tabs 122a. Best seen in FIG. 6, the guide tabs 122a are disposed in spaced relation to each other along the bus bar carrier 122 and combine to define an extended partial path for the wire 140. FIGS. 1, 2 and 4 depict wire 140 having a first portion positioned along majority surfaces of guide tabs 122a so as to define the extended partial wire path. It is understood that guide tabs 122a may be disposed along other portions of the bus bar carrier 122 for extending the partial wire path.

In example embodiments, the stator assembly 100 includes a temperature sensor 142 for use in monitoring a temperature of at least a portion of the stator assembly 100, such as a winding 110. The temperature sensor 142 may be a negative temperature coefficient (NTC) thermistor whose resistance increases or decreases with a decrease or increase, respectively, of the temperature of a winding(s) 110. Specifically, the temperature sensor 142 may include a sensor component 142a (having the NTC thermistor, for example), a connector 142b having an interface for communicating sensor data with a controller (not shown) associated with the stator assembly 100 (and/or the motor in which the stator assembly 100 is a part), and the wire connecting the sensor component 142a and the connector 142b. By monitoring changes in resistance of the NTC thermistor, the controller may be configured to infer motor temperature and control the stator/motor based upon the inferred temperature in order to prevent motor failure.

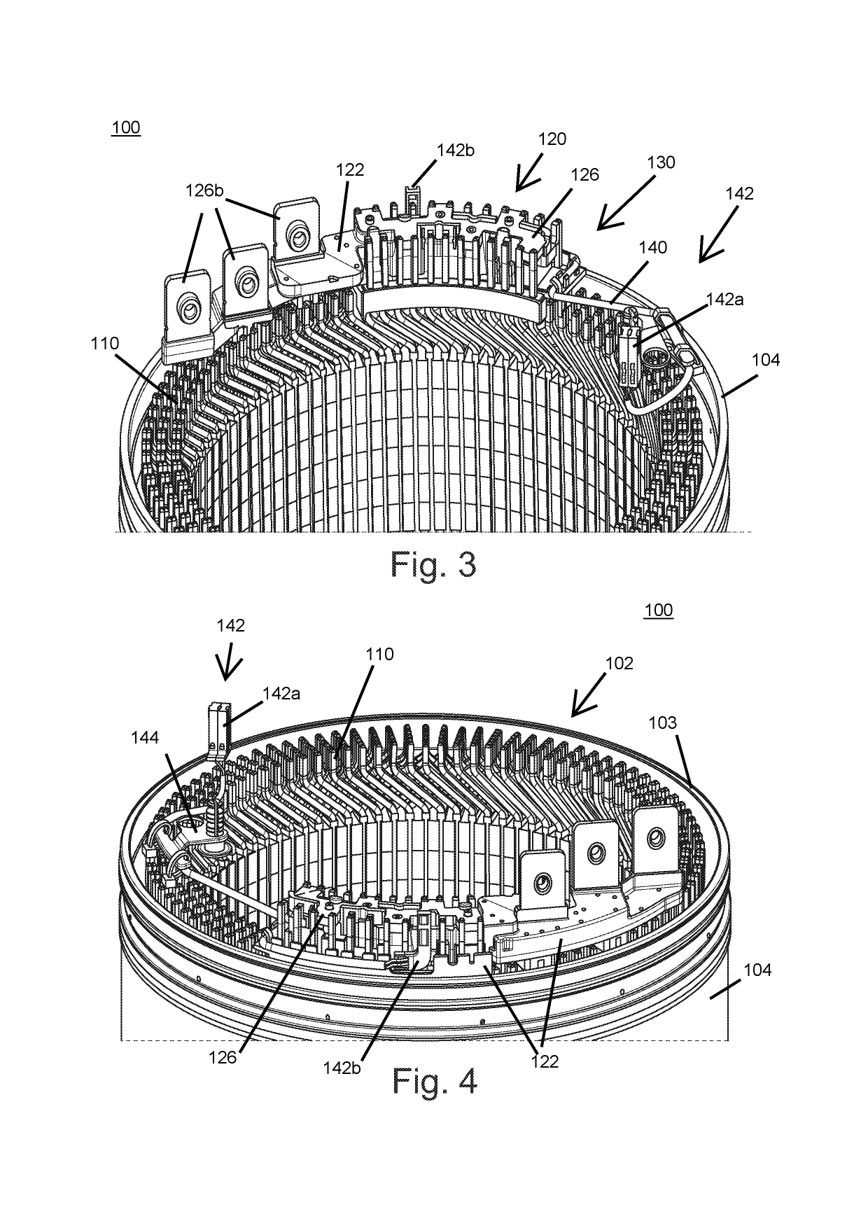

In an example embodiment, the wire 140, which is at least partly held in place by the wire clip assembly 130 as discussed above, is the wire connecting the temperature sensor component 142a and the connector 142b for providing temperature data to the controller. In an example embodiment, the stator assembly 100 may further include a sensor component anchor 144 which engages with the stator assembly 100, such as the stator carrier 104, and engages with the temperature sensor 142 for securing the sensor to the stator. The sensor anchor 144 is best seen in FIGS. 3 and 4. The stator assembly 100 may further include a coupling anchor for securing the coupler 142b to the stator carrier 104, the bus bar carrier 122, or the like.

With the wire clip assembly 130 integrated into the bus bar carrier 122 and utilized to secure at least a portion of the wire 140 of the temperature sensor 142 during stator/motor assembly, by the wire portion being inserted into and retained by clips 134 of the wire clip assembly 130, the portion of the wire 140 secured by the wire clip assembly 130 is prevented from being pinched or otherwise damaged during motor assembly and operation.

A number of implementations have been described. Nevertheless, it will be understood that various modifications may be made without departing from the spirit and scope of the disclosure. Accordingly, other implementations are within the scope of the following claims.

What is claimed is:

1. A bus bar assembly for a stator assembly of an electric motor, the bus bar assembly comprising:
a bus bar in conductive communication with a plurality of windings of the stator assembly, the bus bar comprising a main body portion and a plurality of bus tabs in conductive communication with select windings of the plurality of windings;
a bus bar carrier having a body supporting the bus bar; and
a wire clip assembly supported by the bus bar carrier, the wire clip assembly configured to receive and secure therein at least a portion of an electric wire.

2. The bus bar assembly of claim 1, wherein the wire clip assembly comprises a clip carrier extending from the bus bar carrier, and comprises at least one wire clip extending from the clip carrier.

3. The bus bar assembly of claim 2, wherein the clip carrier is part of and integrally formed with the bus bar carrier as a unitary part.

4. The bus bar assembly of claim 2, wherein the clip carrier, the at least one wire clip, and the bus bar carrier are integrated as a unitary part.

5. The bus bar assembly of claim 2, wherein each wire clip comprises a first arm and a second arm, each arm having a first end connecting to the clip carrier and a second distal end extending away from the first end and the clip carrier, the first arm and second arms defining a receptacle for receiving and securing at least a portion of the wire.

6. The bus bar assembly of claim 2, wherein the at least one wire clip comprises a plurality of wire clips, each wire clip comprising a receptacle configured for receiving and securing therein a portion of the electrical wire, the receptacle formed by a first arm and a second arm, each first and second arm having a first end connecting to the clip carrier and a second distal end extending away from the first end, the receptacles being spaced apart along the clip carrier so as to define a wire path along the clip carrier for securing the electrical wire.

7. The bus bar assembly of claim 6, wherein the wire path includes at least one bend.

8. The bus bar assembly of claim 6, wherein a first length between the first end of the first arm and the second end of the first arm is less than a second length between the first end of the second arm and the second end of the second arm.

9. The bus bar assembly of claim 2, wherein the clip carrier extends from the bus bar carrier in a circumferential direction relative to the stator assembly.

10. An electric motor comprising a stator assembly having the bus bar assembly of claim 1.

11. A stator assembly for an electric motor, the stator assembly comprising:
a stator having a plurality of windings;
bus bar in conductive communication with the plurality of windings, the bus bar comprising a main body portion and a plurality of bus tabs in conductive communication with select windings of the plurality of windings;
a bus bar carrier having a carrier body supporting the bus bar; and
a wire clip assembly supported by the bus bar carrier, the wire clip assembly configured to receive and secure at least a portion of an electric wire.

12. The stator assembly of claim 11, wherein the wire clip assembly comprises at least one wire clip and a clip carrier supporting the at least one wire clip and extending from the bus bar carrier, and wherein the at least one wire clip extends away from the clip carrier.

13. The stator assembly of claim 12, wherein the clip carrier is part of and integrally formed with the bus bar carrier as a unitary part.

14. The stator assembly of claim 12, wherein the clip carrier, the at least one wire clip, and the bus bar carrier are integrated as a unitary part.

15. The stator assembly of claim 12, wherein each wire clip defines a first arm and a second arm, each first and second arm having a first end connecting to the clip carrier and a second distal end extending away from the first end, the first arm and second arms of each wire clip defining a receptacle for receiving and securing the electrical wire.

16. The stator assembly of claim 12, wherein the at least one wire clip comprises a plurality of wire clips, each wire clip forming a receptacle configured for receiving and securing therein the electrical wire, each wire clip comprising a first arm and a second arm, each first and second arm having a first end connecting to the clip carrier and a second distal end extending away from the clip carrier, the wire clips being spaced apart along the clip carrier so as to define a wire path along the clip carrier for securing the electrical wire.

17. The stator assembly of claim 16, wherein the wire path includes at least one bend.

18. The stator assembly of claim 16, wherein a first length between the first and second ends of the first arm is less than a second length between the first and second ends of the second arm.

19. The stator assembly of claim 16, wherein the bus bar carrier comprises one or more guide tabs against which the electrical wire is positioned, the one or more guide tabs and the plurality of wire clips defining the wire path.

20. The stator assembly of claim 11, further comprising a temperature sensor, the electric wire being part of the temperature sensor.
